(19) United States
(12) Patent Application Publication
(10) Pub. No.: US 2012/0127393 A1
(43) Pub. Date: May 24, 2012

(54) DISPLAY DEVICE

(75) Inventor: Tetsuya Hamada, Osaka (JP)

(73) Assignee: SHARP KABUSHIKI KAISHA, Osaka (JP)

(21) Appl. No.: 13/388,278

(22) PCT Filed: Mar. 16, 2010
(86) PCT No.: PCT/JP2010/054389

§ 371 Date: Jan. 31, 2012

(30) Foreign Application Priority Data
Aug. 4, 2009 (JP) 2009-181457

(51) Int. Cl. G02F 1/13357; G02F 1/1333

(52) U.S. Cl. 349/58

(57) ABSTRACT

Disclosed is a display device configured to prevent its size from becoming large. The display device includes a case member (4) and attachment pieces (8) for attachment to an external member, where the attachment pieces (8) are provided on the case member (4). The case member (4) is constituted of a combination of a frame (5) and a bezel (6). Corner portions (5c) of a side section (5b) of the frame (5) disposed at locations of prescribed corner sections (4d) of the plurality of corner sections (4d) of the case member (4) are formed into chamfered surfaces. Also, attachment pieces (8) are disposed at least at the prescribed corner sections (4d) of the case member (4).

### TECHNICAL FIELD

The present invention relates to a display device such as a liquid crystal display device.

### BACKGROUND ART

The liquid crystal display device is known as a conventional display device (see Patent Document 1, for example). Below, the configuration of a conventional liquid crystal display device is described with reference to FIG. 17.

As shown in FIG. 17, a conventional liquid crystal display device includes at least a liquid crystal panel 110 having a display surface 110a, and a backlight unit 120 disposed on the side opposite from the side of the display surface 110a of the liquid crystal display panel 110.

The liquid crystal display panel 110 includes at least a liquid crystal layer, which is not shown, and a pair of glass substrates 111 sandwiching the liquid crystal layer. A backlight unit 120 is an edge-light type, and includes at least a light guide plate 121 and light-emitting elements 122 disposed to face the prescribed side end surface of the light guide plate 121. Also, on the front side (the side facing the liquid crystal display panel 110) and the back side (the side opposite to the front side) of the light guide plate 121, optical sheets 123 and a reflective sheet 124 are disposed, respectively.

A conventional liquid crystal display device further includes a case member 130, which is a combination of a backside case member 131 disposed in proximity of the backlight unit 120 and a front side case member 132 disposed in proximity of the liquid crystal display panel 110. The liquid crystal display panel 110 and the backlight unit 120 are housed in the case member 130, and while the liquid crystal display panel 110 and the backlight unit 120 are housed in the case member 130, the liquid crystal display device is attached to an external member, which is not shown.

### RELATED ART DOCUMENTS

### Patent Documents

Patent Document 1: Japanese Patent Application Laid-Open Publication No. 2005-158384

### SUMMARY OF THE INVENTION

### Problems to be Solved by the Invention

In the conventional configuration described above, in order to attach the liquid crystal display device to an external member (not shown), as shown in FIG. 18, for example, attachment pieces 133 for attachment by screws may be provided on the case member 130 (front side case member 132) such that the attachment pieces protrude from the external surface of the case member 130. Such attachment pieces 133 provided on the case member 130, however, makes the liquid crystal display device larger by the size of the protrusions.

The present invention was devised to solve the problem described above, and is aiming at providing a display device that can prevent the display device size from becoming large.

### Means for Solving the Problems

To achieve the purpose stated above, the display device according to a first aspect of the present invention includes a case member having a plurality of corner sections, a display panel housed in the case member and having a display surface, a backlight unit housed in the case member and disposed on the side opposite from the display surface of the display panel, and an attachment piece provided on the case member for attachment to an external member. The case member is constituted of a combination of a first case member having first side sections and being disposed on a side of the backlight unit, and a second case member having second side sections and being disposed on a side of the display panel. A first portion of a first side section of the first case member, which first portion is disposed at a location of a prescribed corner section among the plurality of corner sections of the case member, is formed into a chamfered surface that is at an inclined angle relative to the remaining portions of the first side sections, and the attachment piece is provided at least at the prescribed corner section of the case member.

Referring to the display device according to the first aspect, as described above, because the first portion of the first side section of the first case member, which first portion is disposed at a location of the prescribed corner section of the plurality of corner sections of the case member, is formed into a chamfered surface (surface that is at an inclined angle relative to the remaining portions of the first side sections), an approximately triangle space is formed in each of the prescribed corner sections of the case member. As a result, when the attachment piece (to be used for attachment of the display device to external members) is provided at the prescribed corner sections of the case member, the attachment piece can be provided within the spaces in the prescribed corner sections of the case member. That is, the attachment piece disposed at the prescribed corner section of the case member does not protrude externally. This configuration can prevent the display device size from becoming large.

Referring to the display device according to the first aspect, the first portion of the first side section of the first case member is formed into the chamfered surface so that a space is formed in the prescribed corner section of the case member. The attachment piece is preferably housed within the space in the prescribed corner section of the case member. This configuration easily ensures that the attachment pieces disposed at the prescribed corner sections of the case member do not protrude externally.

Referring to the display device according to the first aspect, each of the attachment piece is preferably provided as a unified part of the prescribed corner section of the case member. This configuration allows the attachment piece to be easily provided within the spaces in the prescribed corner sections of the case member.

In the configuration where each of the attachment piece is formed as a unified portion of the prescribed corner sections of the case member, it is preferable that the case member is constituted of a plate-shaped member, and the piece bent from the plate-shaped member serves as the attachment piece. Such a configuration easily allows formation of the attachment piece as a unified portion of the prescribed corner section of the case member.

Referring to the display device according to the first aspect, the attachment piece may be provided on the first portion of the first side section of the first case member. Such a configuration allows easy accommodation of the attachment piece within the spaces in the prescribed corner sections of the case member, which spaces are created by forming the first portions of the first side section of the first case member into chamfered surfaces.

Referring to the display device according to the first aspect, a second portion of a second side section of the second case member, which second portion is disposed at a location of the prescribed corner section of the case member, may be formed into a chamfered surface that extends along the first portion of the first side section of the first case member, and the attachment piece may be provided on the second portion of the second side section of the second case member. Such a configuration allows easy accommodation of the attachment pieces within the spaces in the corner sections of the case member, which spaces are created by forming the first portions of the first side section of the first case member into chamfered surfaces.

Referring to the display device according to the first aspect, the backlight unit preferably includes a light-emitting element and a light guide plate having a plurality of corners. It is also preferable that the light-emitting element is attached to the first portion of the first side section of the first case member so that the light-emitting element is disposed at least at one of the plurality of corners of the light guide plate. In this configuration, because the LED (Light-Emitting Diode), which generates the light that advances while spreading radially, is used as a light-emitting element, the light can be distributed to approximately entire area inside the light guide plate without the need to increase the number of the light-emitting elements to be used or to move the light-emitting element away from the light guide plate. As a result, uneven luminance can be suppressed without increasing the cost or size of the display.

Further, because the light-emitting element is attached to the first portion of the first side section of the first case member (the prescribed corner of the case member at which the attachment piece is provided), the heat generated by the light-emitting elements is easily transmitted to the external member for dissipation through the attachment piece. As a result, the deterioration of the light-emitting element due to the heat generated by itself is suppressed, and the service life of the light-emitting element can be extended. Also, the operating temperature range of the display device can be widened (to a higher side).

In the case that the backlight unit as described above is used, it is more preferable that a portion of a side surface of the light guide plate at a corner, at which the light-emitting element is disposed, is formed into a surface at an inclined angle relative to the other portion of the side surface, and the light-emitting element is attached to the first portion of the first side section of the first case member so that the light-emitting element is disposed to face the inclined surface of the side surface of the light guide plate. With this configuration, the light can easily be distributed to the entire area inside the light guide plate.

Also, in the configuration where a portion of a side surface of the light guide plate at a corner, at which the light-emitting element is disposed, is formed into a surface at an inclined angle relative to the other portion of the side surface, it is preferable that the first portion of the first side section of the first case member is formed into the chamfered surface that extends along the corresponding inclined side surfaces of the light guide plate. In this configuration, with the light-emitting elements attached to the first portions of the first side section of the first case member, the light-emitting element can easily be disposed against the inclined side surface of the light guide plate.

### Effects of the Invention

As described above, according to the present invention, a display device configured to prevent its size from becoming large can easily be obtained.

### BRIEF DESCRIPTION OF THE DRAWINGS

FIG. 1 is an exploded perspective view of a display device according to Embodiment 1.

FIG. 2 is a plan view of the backlight unit attached to a display device according to Embodiment 1 (the reflective sheet and the optical sheet are omitted in the figure).

FIG. 3 is a cross-sectional view of the backlight unit attached to a display device according to Embodiment 1.

FIG. 4 shows the configurations of the frame and the bezel of a display device of Embodiment 1.

FIG. 5 is a plan view showing the frame of a display device of Embodiment 1.

FIG. 6 is an enlarged perspective view of a portion of the frame shown in FIG. 5 (the portion around the attachment pieces provided as a unified portion of the frame).

FIG. 7 shows the behavior of the light inside the light guide plate.

FIG. 8 shows the behavior of the light inside the light guide plate.

FIG. 9 shows the behavior of the light inside the light guide plate.

FIG. 10 is a plan view of a backlight unit when a larger light guide plate is employed to reduce uneven luminance (the reflective sheet and the optical sheet are omitted in the figure).

FIG. 11 is an exploded perspective view of a display device of Embodiment 2.

FIG. 12 illustrates the structure of the frame and the bezel of a display device of Embodiment 2.

FIG. 13 is a plan view of the bezel of a display device of Embodiment 2.

FIG. 14 is an enlarged perspective view of a portion of the bezel shown in FIG. 13 (the portion around the attachment pieces provided as a unified portion of the bezel).

FIG. 15 is an enlarged view of a portion of the backlight unit of a display device according to an modification example of the present invention (the portion where LEDs are disposed).

FIG. 16 is an enlarged view of a portion of the backlight unit of a display device according to a modification example of the present invention (the portion where LEDs are disposed).

FIG. 17 is an exploded perspective view of a conventional liquid crystal display device.

FIG. 18 illustrates a problem with a conventional device.

### DETAILED DESCRIPTION OF EMBODIMENTS

### Embodiment 1

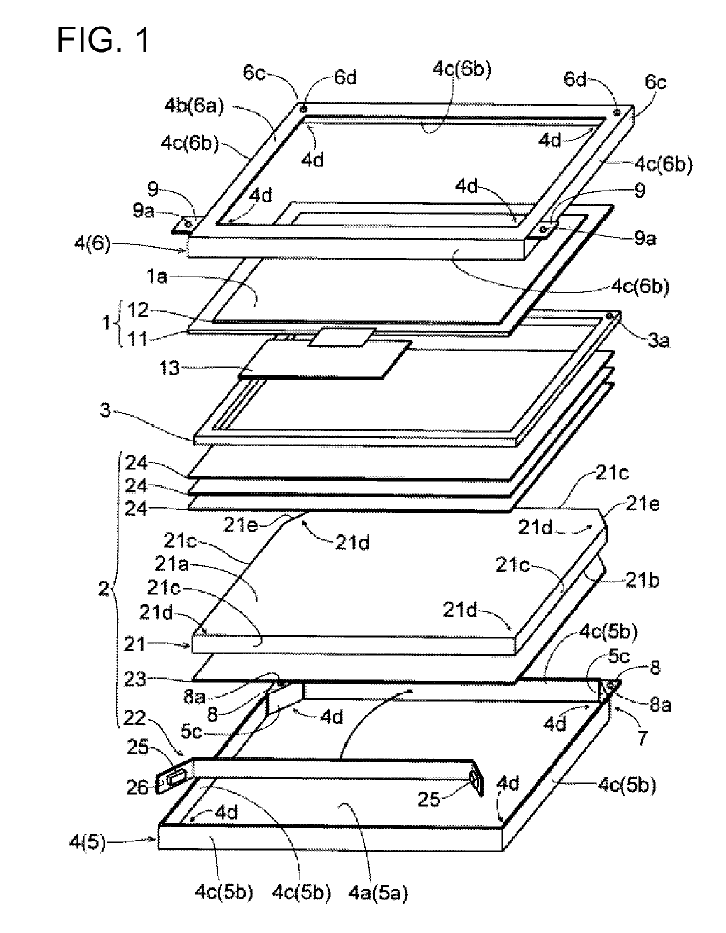

The configuration of a display device according to Embodiment 1 is described with reference to FIG. 1 to FIG. 6.

The display device according to Embodiment 1 is a liquid crystal display device. As shown in FIG. 1, the display device includes, among others, a liquid crystal display panel 1 having a display surface 1a, and an edge-light type backlight unit 2 disposed on the back side (the side opposite from the display surface 1a) of the liquid crystal display panel 1. The liquid crystal display panel 1 is an example of “display panel” of the present invention.

The liquid crystal display panel 1 includes at least a liquid crystal layer (not shown), a pair of glass substrates 11 sandwiching the liquid crystal layer, and polarizing plates 12, which are disposed on the respective glass substrates 11 on the surfaces not facing the liquid crystal layer. To one of the pair of glass substrates 11, a driver circuit 13 for driving thin film transistors (not shown) formed on the substrate is connected.

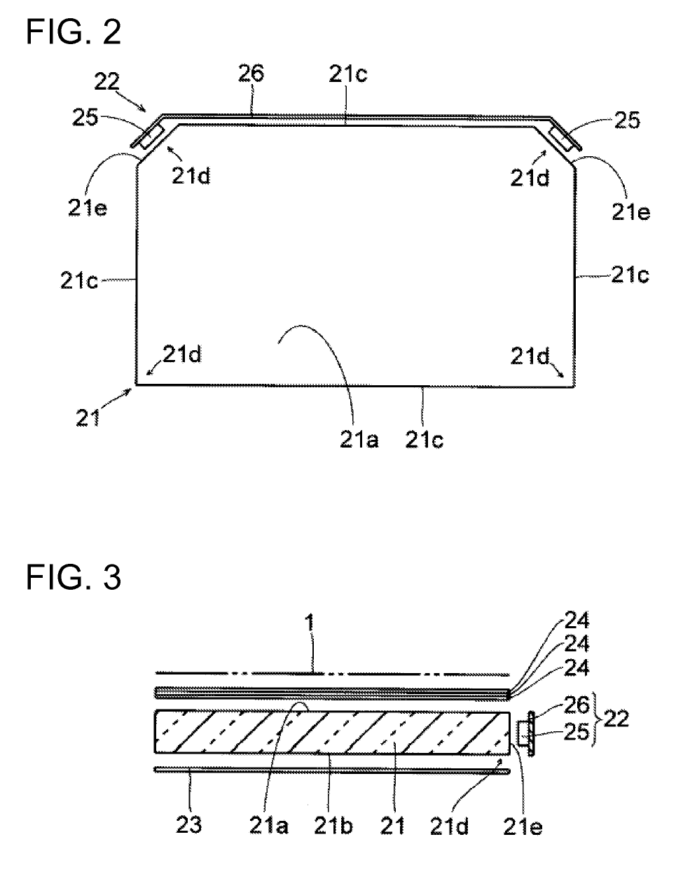

As shown in FIG. 1 to FIG. 3, the backlight unit 2 includes at least a light guide plate 21, an LED module 22, a reflective sheet 23, and optical sheets 24. For simplicity, the reflective sheet 23 and the optical sheets 24 are not shown in FIG. 2.

The light guide plate 21 is constituted of light-transmissive plate-shaped members. The light that enters the light guide plate 21 is converted into planar light and the planar light is projected towards the liquid crystal display panel 1. Specifically, the light guide plate 21 includes a top surface 21a, a back surface 21b which is the surface opposite from the top surface 21a, and side surfaces 21c connecting the top surface 21a and the back surface 21b. With the backlight unit 2 disposed on the back surface side of the liquid crystal display panel 1, the top surface 21a of the light guide plate 21 faces the liquid crystal display panel 1. That is, the top surface 21a of the light guide plate 21 serves as the light-projecting surface (the surface through which the light introduced into the light guide plate is projected towards the liquid crystal display panel 1 as planar light).

Also, when the light guide plate 21 is viewed from the direction of the plate thickness, the light guide plate 21 has a shape with four corners 21d (approximately rectangular shape). At the two of the four corners 21d located on each end of one of the longer sides (one end of each of the pair of shorter sides), a light introducing surface (the surface through which the light is introduced into the light plate guide) is formed. The light-introducing surfaces formed at the two corners 21d of the light guide plate 21 are inclined surfaces 21e obtained by bending a portion of a side surface 21c that is adjacent to the corner 21d to an oblique direction toward another side surface 21c. Each of the two inclined surfaces 21e of the light guide plate 21 has an inclination angle of approx. 45°, and is mirror-finished.

The LED module 22 is composed of LEDs 25 as light-emitting elements, mounted on a FPC (flexible printed circuit board) 26. The LED module 22 functions as the light source that generates the light to be introduced into the light guide plate 21. That is, the LED module 22 is provided on one of the longer sides of the light guide plate 21 such that the light-emitting surfaces of the LEDs 25 face the corresponding inclined surfaces 21e of the light guide plate 21.

In Embodiment 1, two LEDs 25 are used, and one of the LEDs is disposed at respective one of the two locations, facing the corresponding inclined surface 21e of the light guide plate 21. That is, one LED 25 is disposed at each of two of the four corners 21d of the light guide plate 21. The two LEDs 25 are mounted on the same FPC 26, and the FPC 26 is bent along the side surface 21c (also the two inclined surfaces 21e) of one of the longer sides of the light guide plate 21. That is, each end portions of the FPC 26 faces one of the two inclined surfaces 21e of the light guide plate 21, and the middle portion of the FPC 26, i.e., the portion between the two end portions of the FPC 26, faces the side surface 21c of the light guide plate 21 which is not inclined (the side surface located between the two inclined surfaces 21e). Also, one LED 25 is respectively mounted on both end portions of the FPC 26.

A reflective sheet 23 is disposed on the back surface 21b of the light guide plate 21, covering the entire back surface 21b of the light guide plate 21. With the reflective sheet 23 in place, the back surface 21b of the light guide plate 21 becomes a reflective surface, which suppresses the light leakage from the back surface 21b of the light guide plate 21 and improves the light use efficiency.

Optical sheets 24 are disposed on the top surface 21a of the light guide plate 21, covering the entire top surface 21b of the light guide plate 21. The optical sheets 24 are a plurality of sheets (such as diffusion sheets or prism sheets) layered together, and they diffuse or focus the light projected from the top surface 21a of the light guide plate 21. The liquid crystal display panel 1 is irradiated with the light diffused or focused by the optical sheets 24. FIG. 1 and FIG. 3 illustrate optical sheets 24 as three layers of sheets, but the number of the sheets is not especially limited.

As shown in FIG. 1, a frame-shaped plastic frame 3 is disposed between the liquid crystal display panel 1 and the backlight unit 2. The fringes of the optical sheets 24 are pressed against the fringe portion of the plastic frame 3, and thereby a laminated body of the reflective sheets 23, the light guide plate 21, and the optical sheets 24 layered in this order are held in place.

Further, the liquid crystal display panel 1 and the backlight unit 2 are housed in a box-shaped case member 4 with the plastic frame 3 interposed between them.

The case member 4 housing the liquid crystal display panel 1 and the backlight unit 2 is a combination of two members (frame 5 and bezel 6), and includes a bottom section 4a, top surface section 4b, and side sections 4c bordering a prescribed region. The case member 4 is formed such that the region bordered by the side sections 4c of the case member 4 has an approximately rectangular shape having four corner sections 4d, and the approximately rectangular region bordered with the side sections 4b of the case member 4 serves as the housing region. Also, a frame 5 and a bezel 6, which are constituting members of the case member 4, are respectively an example of “first case member” and “second case member” of the present invention.

The frame 5 is obtained by processing a plate member made of a material such as aluminum or iron. The frame 5 has a bottom section 5a and side sections 5b disposed to border the bottom section 5a. The bottom section 5a and the side sections 5b of the frame 5 serve as the bottom section 4a and the side section 4b of the case member 4, respectively. The side section 5b of the frame 5 is an example of “first side section” of the present invention.

In the housing region of the frame 5, constituting members (21 to 24) of the backlight unit 2 are housed. The reflective sheet 23, the light guide plate 21, and the optical sheets 24 are layered in this order on the bottom section 5a of the frame 5. Here, the back side 21b of the light guide plate 21 faces the bottom section 5a of the frame 5, and the side surfaces 21c of the light guide plate 21 including two inclined surfaces 21e face the side sections 5b of the frame 5. The longer sides of the light guide plate 21 and the longer sides of the frame 5 are approximately parallel with each other, and the shorter sides of the light guide plate 21 and the shorter sides of the frame 5 are approximately parallel with each other. Also, the locations of the four corners 21d of the light guide plate 21 approximately correspond to the locations of the four corner sections of the frame 5 (four corner sections 4d of the case member 4). That is, one inclined surface 21e of the light guide plate 21 is disposed for each one of the two of the four corner sections 4d of the case member 4.

Also, the inclined surfaces 21e of the light guide plate 21 are each disposed at locations corresponding to respective two of the four corner sections 4d of the case member 4. The corner portions 5c of the side sections 5b of the frame 5 disposed at the two corner sections 4d of the case member 4 are formed into chamfered surfaces that are at an inclined angle relative to other portion of the side sections 5b (surfaces extending along the inclined surfaces 21e of the light guide plate 21). That is, along the side surface 21c (including two inclined surfaces 21e) of one of the longer sides of the light guide plate 21, the side section 5b (including two corner portions 5c) of one of the longer sides of the frame 5 is bent. The corner portion 5c of the side section 5b of the frame 5 is an example of “first portion” of the present invention.

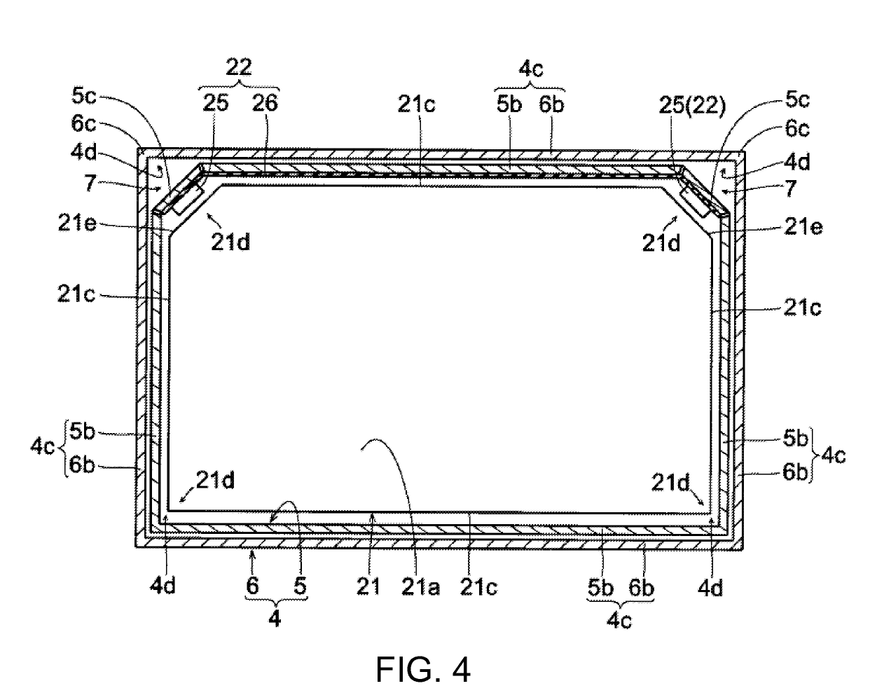

Also, as shown in FIG. 4, the LED module 22 is attached to the inner side of the side section 5b of one of the longer sides of the frame 5. Thus, one LED 25 is disposed for each of the two corner portions 5c of the side section 5b of the frame 5, and the light-emitting surfaces of the two LEDs 25 face the corresponding inclined surfaces 21e of the light guide plate 21.

Also, as shown in FIG. 1, the bezel 6 is obtained by processing a plate member made of a material such as stainless steel or iron. The bezel 6 has a picture frame-shaped top surface section 6a and side sections 6b disposed to border the top surface section 6a. Also, the top surface section 6a of the bezel 6 constitutes the top surface section 4b of the case member 4, and the side sections 6b of the bezel 6 constitute, together with the side sections 5b of the frame 5, the side sections 4c of the case member 4. The side section 6b of the bezel 6 is an example of “second side section” of the present invention.

The bezel 6 is fitted to the frame 5 by installing the side sections 5b of the frame 5 within the region bordered with the side sections 6b of the bezel 6, and engaging the side sections 6b of the bezel 6 to the side sections 5b of the frame 5. Once the bezel 6 is fitted to the frame 5, the fringe of the display surface 1a of the liquid crystal display panel 1 is covered with the top surface section 6a of the bezel 6. Unlike the corner portions 5c of the side section 5b of the frame 5, the two corner portions 6c of the side section 6b of the bezel 6, close to which LEDs 25 are to be disposed, are not chamfered, but form an approximately right angle.

In Embodiment 1, the case member 4 (frame 5 and bezel 6) described above is used. With such a case member 4 in place, as shown in FIG. 1 and FIG. 4, a space 7 is formed in two of the four corner sections 4d of the case member 4 at which LEDs 25 are disposed. That is, at each of the two of the four corner sections 4d of the case member 4 where LEDs 25 are to be disposed, the corner portion 5c of the side section 5b of the frame 5 is chamfered. As a result, an approximately triangle space 7 is formed between the corner portion 5c of the side section 5b of the frame 5 and the corner portion 6c of the side section 6b of the bezel 6.

Also in Embodiment 1, the spaces 7 formed in two of the four corner sections 4d of the case member 4 at which LEDs 25 are disposed are used to attach the display device to an external member (not shown). Specifically, at locations corresponding to the two of the four corner sections 4d of the case member 4 at which LEDs 25 are to be disposed, attachment pieces 8 are provided as unified parts of the corner portions 5c of the side section 5b of the frame 5 such that the attachment pieces 8 are disposed within the spaces 7.

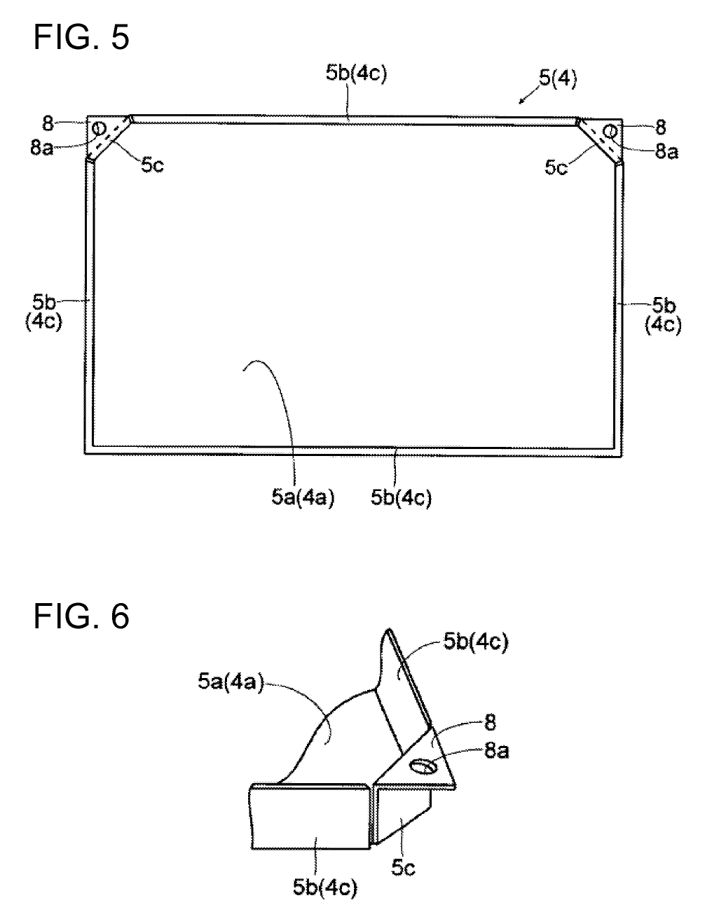

The attachment pieces 8, as shown in FIG. 5 and FIG. 6, are pieces of metal obtained by bending the metal plate constituting the frame 5, and are formed into an approximately triangle shape reflecting the shape of the space 7 (see FIG. 4). Each of the attachment pieces 8 has a through hole 8a for passing an attachment screw (not shown).

Also, as shown in FIG. 1, through holes 3a and 6d are respectively formed in the plastic frame 3 at locations that overlap the attachment pieces 8 and in the bezel 6 at locations that overlap the attachment pieces 8 for passing attachment screws (not shown). The display device is attached to an external member (not shown) by first passing the attachment screws through the through holes 6d in the bezel 6, the through holes 3a in the plastic frame 3, and the through holes 8a in the attachment pieces, and then screwing the attachment screws into the external member.

The remaining two of the four corner sections 4d of the case member 4 at which LED 25 is not present are also provided with attachment pieces 9 which are also used, in addition to the attachment pieces 8, to attach the display device to an external member (not shown). Like the attachment pieces 8, a through hole 9a for passing the attachment screws (not shown) is formed in each of the attachment pieces 9.

In Embodiment 1, as described above, because the corner portions 5c of the side section 5b of the frame 5 disposed at locations of the prescribed corner sections (two corner sections where LEDs 25 are disposed) 4d of the four corner sections 4d of the case member 4 are chamfered, an approximately triangle space 7 is formed in each of the prescribed corner sections 4d. The attachment pieces 8 can, therefore, be disposed within the spaces 7. That is, the attachment pieces 8 can be disposed in the prescribed corner sections 4d of the case member 4 such that they do not protrude externally. Thus, the liquid crystal display device size can be prevented from becoming large.

In Embodiment 1, as described above, the attachment pieces 8 are provided as unified parts of the corner portions 5c of the side section 5b of the frame 5. This configuration allows the attachment pieces 8 to be easily housed within the spaces 7 of the prescribed corner sections 4d of the case member 4, which spaces are formed as a result of making the corner portions 5c of the side section 5b of the frame 5 as chamfered surfaces. Further, formation of attachment pieces 8 by bending the metal plate, which is a constituting member of the frame 5, can easily provide attachment pieces 8 as unified parts of the corner portions 5c of the side section 5b of the frame 5.

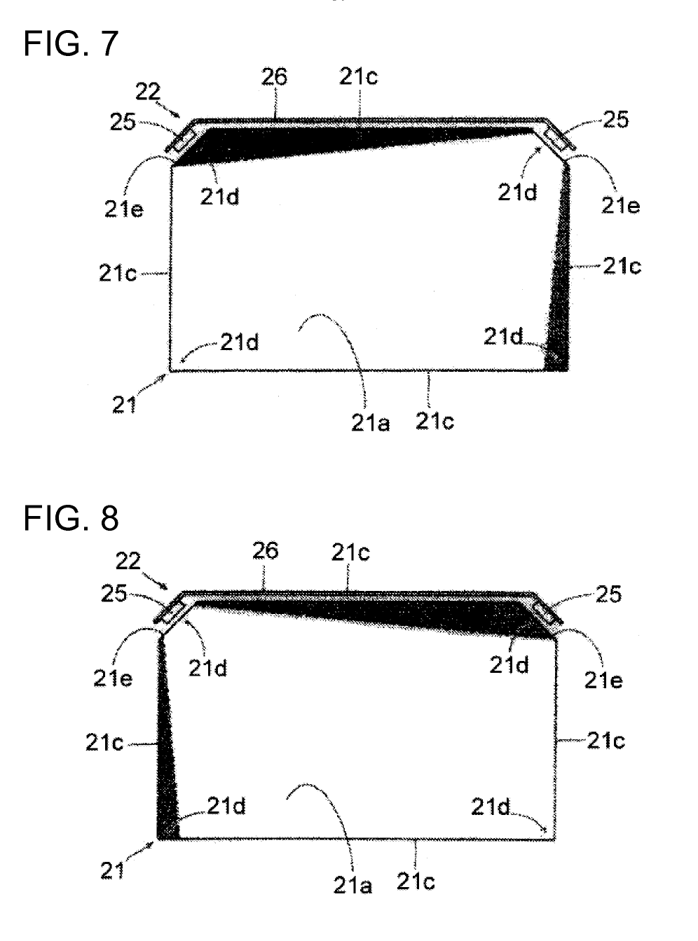

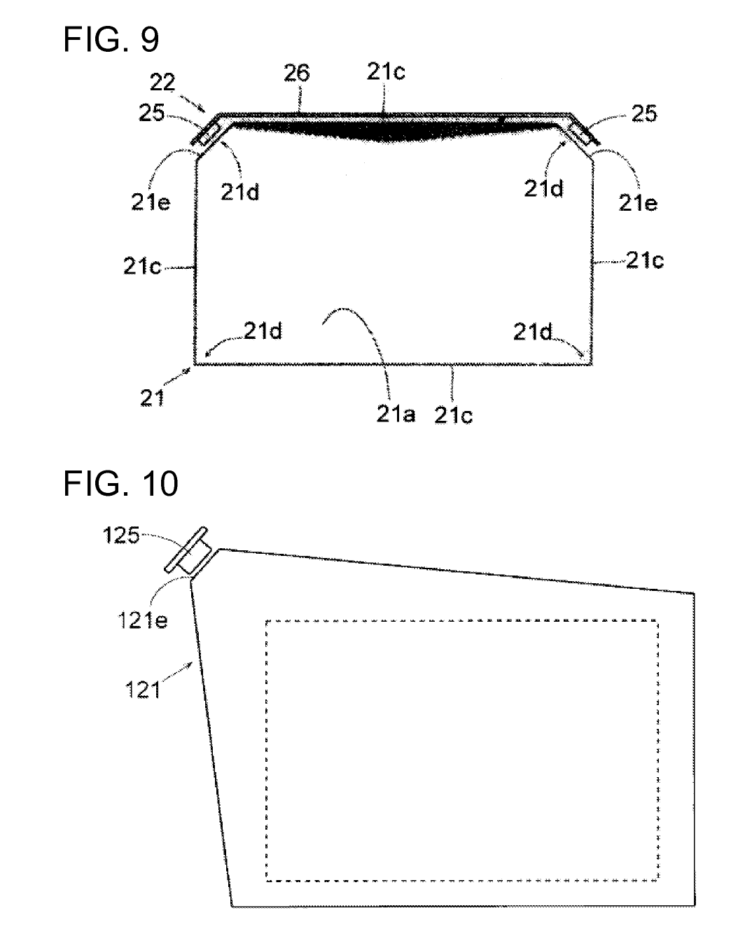

Also, in Embodiment 1, as described above, inclined surfaces 21e are formed from the end portions of a side surface 21c, which are adjacent to two of the four corners 21d of the light guide plate 21. For each of the two inclined surfaces 21e of the light guide plate 21, an LED 25 is disposed such that the light-emitting surface of the LED 25 faces the inclined surface 21e. This way, the light from one of the LEDs 25 spreads inside the light guide plate 21 as shown in FIG. 7, and the light from the other LED 25 spreads inside the light guide plate 21 as shown in FIG. 8. As a result, as shown in FIG. 9, the light is distributed to the entire area inside the light guide plate 21, minimizing the dark area, i.e., the area where the light cannot easily be reached. Thus, planar light with reduced luminance unevenness can be delivered from the backlight unit 2. The hatched areas in FIG. 7 to FIG. 9 are dark areas and the remaining area is the area to which the light is well distributed.

If an LED is disposed only at one of the four corners of the light guide plate to reduce the luminance unevenness, a light guide plate 121 as shown in FIG. 10 needs to be manufactured. That is, because the light from the LED 125 does not spread inside the light guide plate 121 beyond the area of approximately ±42°, in order to distribute the light from the LED 125 to approximately the entire effective light-emitting area (the area bordered with the dotted line), the light-introducing surface 121e of the light guide plate 121 must be disposed at a distance from the effective light-emitting area. In this case, the luminance unevenness can be reduced, but the liquid crystal display device becomes large.

Here, in order to obtain the effect against the luminance unevenness described above, an LED 25 must be disposed at each of the two of the four corners 21d of the light guide plate 21. According to the configuration of Embodiment 1, an LED 25 can easily be disposed at both of the two corners 21d of the light guide plate 21. That is, by providing an LED 25 at each of the two corner portions 5c of the side section 5b of the frame 5, an LED 25 can easily be disposed at two corners 21d of the light guide plate 21.

Also, because the corner portions 5c of the side section 5b of the frame 5 are chamfered to extend along the inclined surfaces 21e of the light guide plate 21, by providing LEDs 25 at the corner portions 5c of the side section 5b of the frame 5, the LEDs 25 can easily be disposed such that the light-emitting surfaces of the LEDs 25 face the inclined surfaces 21e of the light guide plate 21.

Further, because LEDs 25 are disposed at corner portions 5c of the side section 5b of the frame 5 (the portions where the attachment pieces 8 are provided as unified parts), the heat generated by the LEDs 25 is easily transmitted to the external member for dissipation through the attachment pieces 8. As a result, the deterioration of the LED 25 due to the heat generated by itself is suppressed, and the service life of the LED 25 can be extended. Also, the operating temperature range of the liquid crystal display device can be widened (to a higher side).

### Embodiment 2

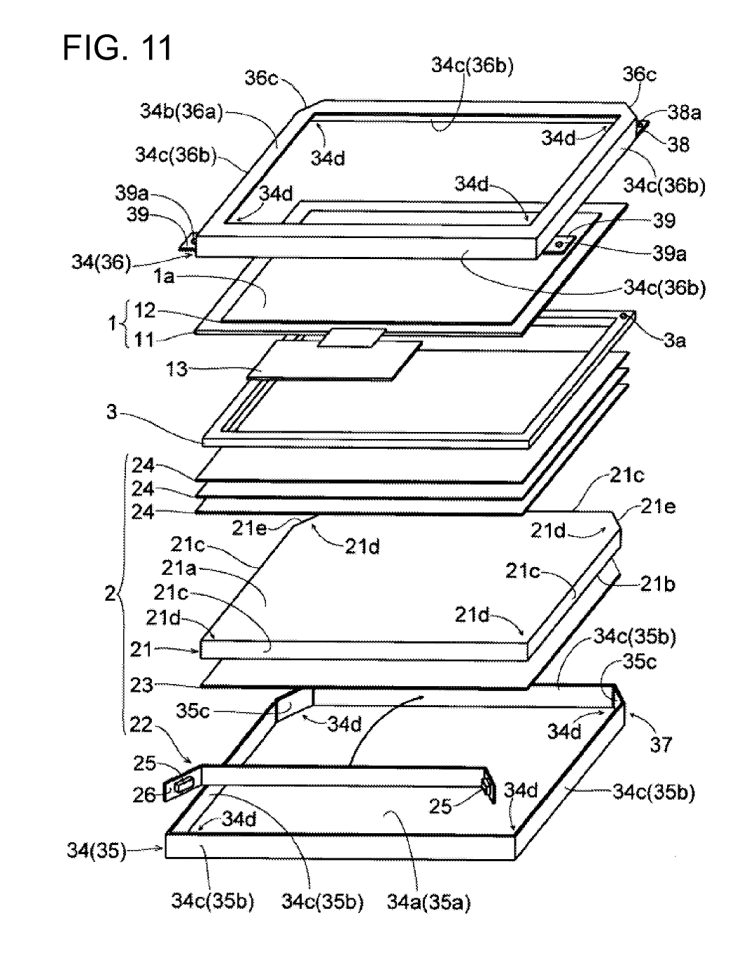

Below, the configuration of a display device according to Embodiment 2 is described with reference to FIG. 11 to FIG. 14.

The configuration of Embodiment 2 is the same as the configuration of Embodiment 1, except that in Embodiment 2, a case member 34 as shown in FIG. 11 is used.

The case member 34 is a combination of a frame 35 disposed on the backlight unit 2 side, and the bezel 36 disposed on the liquid crystal display panel 1 side, and includes a bottom section 34a, a top surface section 34b, and side sections 34c bordering the area that becomes a housing region. The region bordered by the side sections 34c of the case member 34 is configured to have an approximately rectangular shape with four corner sections 34d. The frame 35 is an example of “first case member” of the present invention, and the bezel 36 is an example of “second case member” of the present invention.

The frame 35, which is similar to the frame 5 of Embodiment 1, has a bottom section 35a that serves as the bottom section 34a of the case member 34, and side sections 35b that serve as the side sections 34c of the case member 34. Further, two corner portions 35c of the side section 35b of the frame 35 are formed into chamfered surface that is at an inclined angle relative to the remaining portion of the side section 35b (to extend along the inclined surfaces 21e of the light guide plate 21). The side section 35b of the frame 35 is an example of “second side section” of the present invention, and the corner portion 35c of the side sections 35b is an example of “second portion” of the present invention.

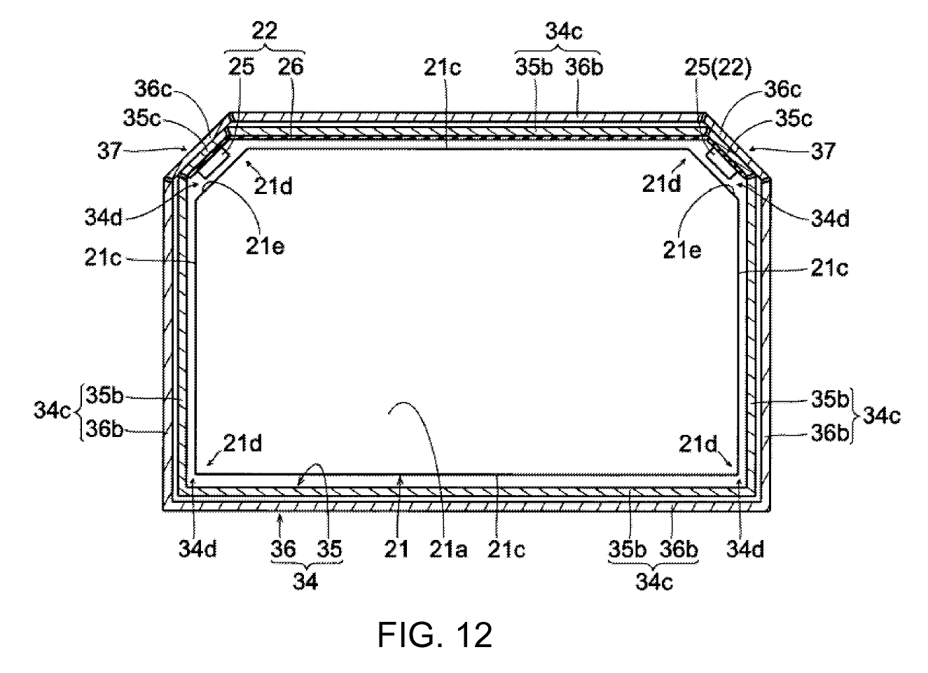

As shown in FIG. 12, with an LED 25 attached to each of the two corner portions 35c of the side section 35b of the frame 35, the LED 25 is disposed at two of the four corner sections 34d of the case member 34. That is, one LED 25 is disposed at each of the two of the four corners 21d of the light guide plate 21, and the light-emitting surface of each of the two LEDs 25 faces an inclined surface 21e of the light guide plate 21.

As shown in FIG. 11, the bezel 36 is similar to the bezel 6 of Embodiment 1, having a top surface section 36a that constitutes the top surface section 34b of the case member 34, and side sections 36b that constitute, together with the side sections 35b of the frame 35, the side sections 34c of the case member 34. The side section 36b of the case member 36 is an example of “second side section” of the present invention.

Here, in Embodiment 2, as shown in FIG. 11 and FIG. 12, attachment pieces 38 provided as unified portions of the bezel 36 are disposed within the spaces 37 formed in two of the four corner sections 34d of the case member 34 where LEDs 25 are disposed (the spaces are formed by making the corner portions 35c of the side section 35b of the frame 35 chamfered surfaces).

Specifically, the corner portions 36c of the side section 36b of the bezel 36 corresponding to the two of the four corner sections 34d of the case member 34 where LEDs 25 are disposed are formed into chamfered surfaces that extend along the corner portions 35c of the side section 35b of the frame 35, and attachment pieces 38 are provided as unified parts of the corner portions 36c of the side section 36b of the bezel 36. That is, in Embodiment 2, no attachment piece 38 is provided at corner portions 36c of the side section 35b of the frame 35.

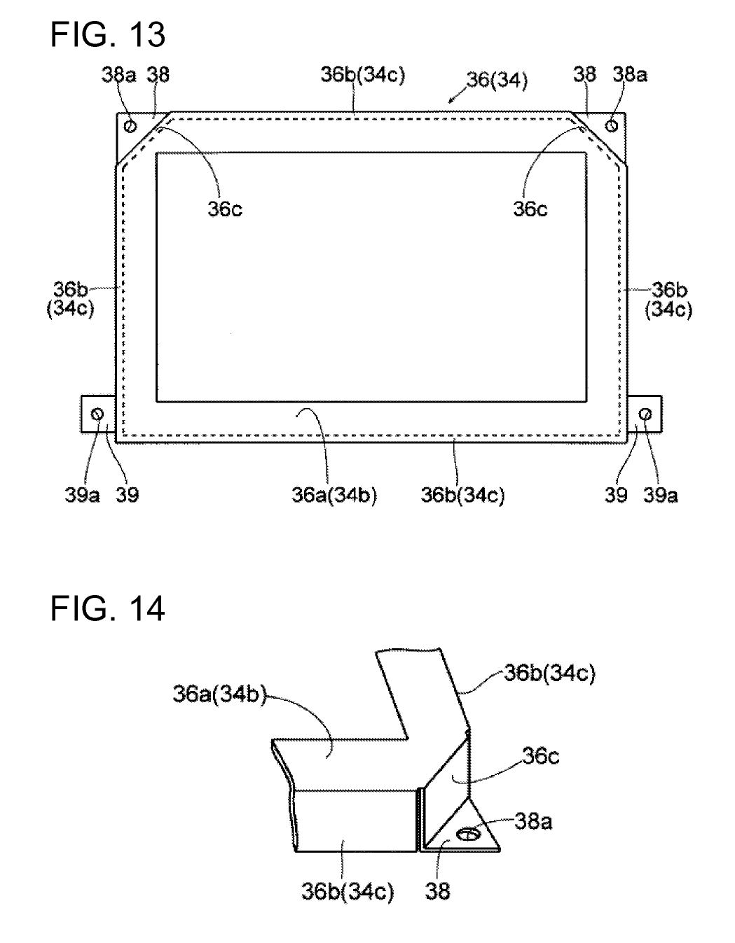

The attachment pieces 38 are metal pieces obtained by bending the metal plate constituting the bezel 36 as shown in FIG. 13 and FIG. 14, and are formed into an approximately triangle shape reflecting the shape of the space 37 (see FIG. 12). Also, each of the attachment pieces 38 has a through hole 38a for passing the attachment screw (not shown).

As shown in FIG. 11, attachment pieces 39 having a through hole 39a for passing an attachment screw (not shown) are also provided at the two of the four corner sections 34d of the case member 34, where no LED 25 is present.

In Embodiment 2, as described above, the corner portions 35c of the side section 35b of the frame 35 disposed at the locations of the prescribed corner sections 34d of the four corner sections 34d of the case member 34 (two corner sections where LEDs 25 are disposed) are formed into chamfered surfaces. Further, the corner portions 36c of the side section 36b of the bezel 36 disposed at the locations of the prescribed corner sections 34d of the case member 34 are also formed into chamfered surfaces. As a result, a space 37 can be formed in each of the prescribed corner sections 34d of the case member 34. Consequently, with the attachment pieces 38 provided within the spaces 37 of the prescribed corner sections 34d of the case member 34, the attachment pieces 38 do not protrude externally, and therefore the liquid crystal display device can be prevented from becoming large.

Also, in Embodiment 2, with attachment pieces 38 provided as unified parts of the corner portions 36c of the side section 36b of the bezel 36 as described above, the attachment pieces 38 can easily be housed in the spaces 37 of prescribed corner sections 34d of the case member 34. Further, because the attachment pieces 38 are bent from the metal plate that is a constituting member of the bezel 36, attachment pieces 38 as unified parts of the corner portions 36c of the side section 36b of the bezel 36 can easily be formed.

Other effects of Embodiment 2 are the same as the effects of Embodiment 1.

Embodiments disclosed herein should be considered as examples in all aspects, and not limiting in any way. The scope of the present invention is defined not by the descriptions of embodiments above, but by the appended claims, and all changes that come within the meaning and the range of equivalency of the claims are intended to be embraced therein.

For example, in embodiments described above, a space for attachment pieces is provided at two of the four corner sections of the case member, but the present invention is not limited to such. A space for the attachment piece may be provided at three of the four corner sections of the case member, or a space for the attachment piece may be provided at all corner sections of the case member. In particular, if a space for accommodating the attachment piece is provided at all corner sections of the case member, there will be no attachment pieces that protrude externally. This means that the size of the liquid crystal display device can be further reduced.

In embodiments described above, LEDs are disposed at two of the four corners of the light guide plate. However, the present invention is not limited to such. LEDs may be disposed at three or more of the four corners of the light guide plate. That is, side surfaces of three or more corners of the four corners of the light guide plate may be inclined surfaces, and each of the three or more inclined surfaces of the light guide plate may be used as a light-introducing surface. Such a configuration further reduces the dark region and the occurrence of the uneven luminance. The LED may also be disposed at just one of the four corners of the light guide plate.

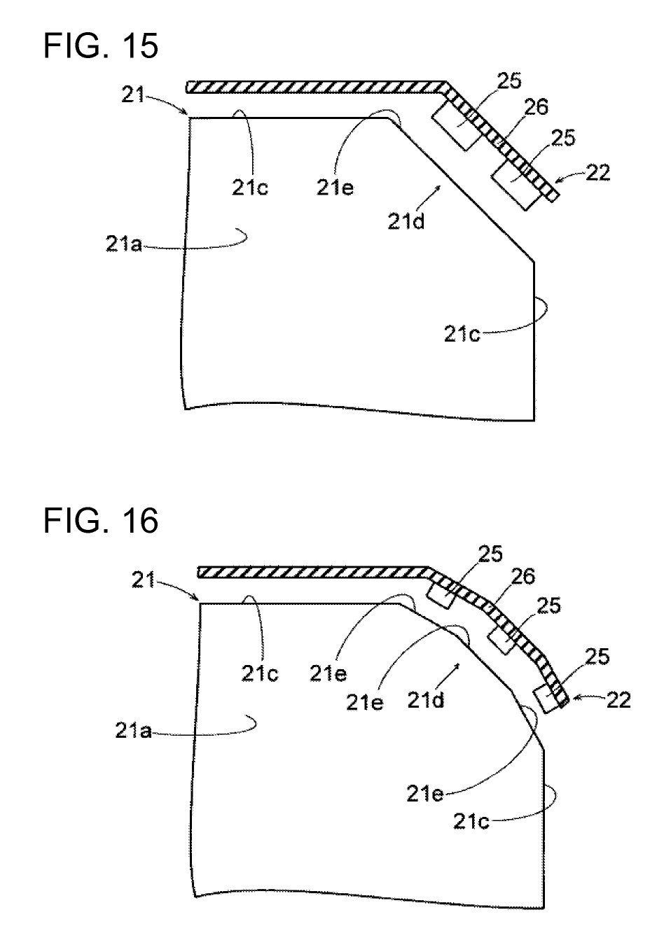

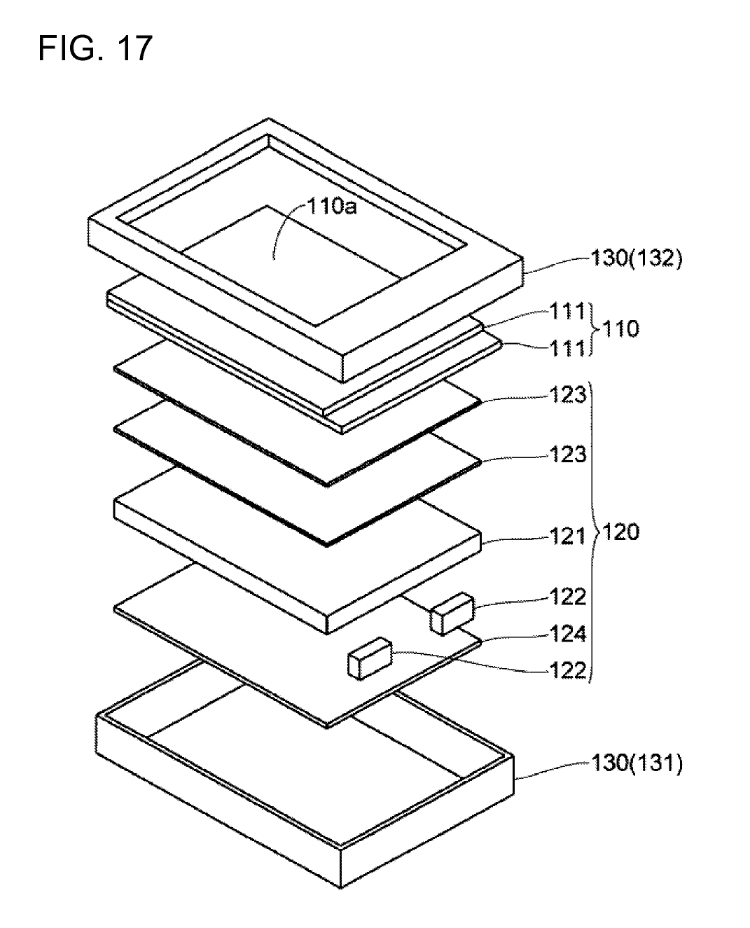

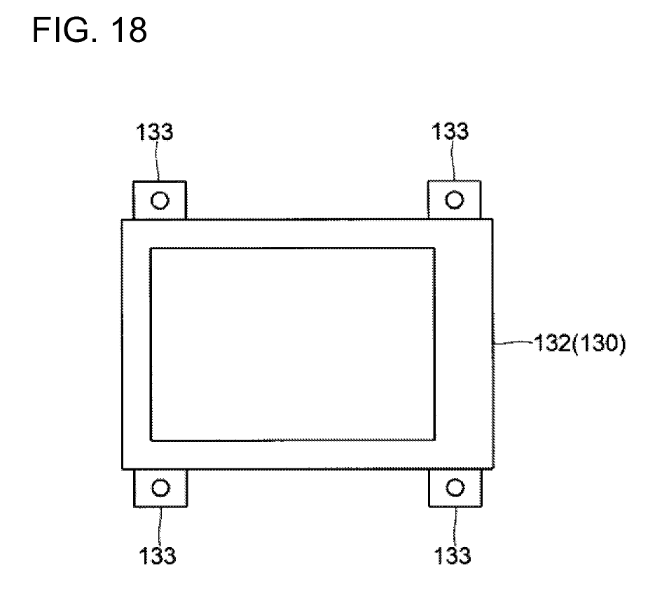

In embodiments described above, one LED is disposed against one inclined surface (light-introducing surface) of the light guide plate. However, the present invention is not limited to such, and a plurality of LEDs may be disposed against one inclined surface of the light guide plate. For example, as shown in FIG. 15, two LEDs 25 may be disposed against one inclined surface (light-introducing surface) 21e of the light guide plate 21.

In embodiments described above, one inclined surface (light-introducing surface) is formed at one corner of the light guide plate. However, the present invention is not limited to such. A plurality of inclined surfaces may be formed at one corner of the light guide plate, where the angles of inclination of the inclined surfaces are different from one another, and an LED may be provided for each of the plurality of inclined surfaces. That is, the light-introducing surface of the light guide plate may be configured to have a multi-surface structure. For example, as shown in FIG. 16, at one corner 21d of the light guide plate 21, three inclined surfaces (light-introducing surfaces) 21e may be formed, and against each of the three inclined surfaces 21e, one LED 25 may be disposed.

### Description of Reference Characters

1 liquid crystal display panel (display panel)

1a display surface

2 backlight unit

4, 34 case member

4d, 34d corner section

5, 35 frame (first case member)

5b, 35b side section (first side section)

5c, 35c corner portion (first portion)

6, 36 bezel (second case member)

6b, 36b side section (second side section)

7, 37 space

8, 38 attachment piece

21 light guide plate

21d corner

25 LED (light-emitting element)

36c corner portion (second portion)

1. A display device comprising:
a case member including a plurality of corner sections;
a display panel housed in said case member and having a display surface;
a backlight unit housed in said case member and disposed on a side opposite from a side of the display surface of said display panel; and
an attachment piece provided on said case member for connection to an external member,
wherein said case member is a combination of a first case member having first side sections and being disposed on a side of said backlight unit, and a second case member having second side sections and being disposed on a side of said display panel, and
wherein a first portion of a first side section of said first case member, which first portion is disposed at a location of a prescribed corner section among the plurality of corner sections of said case member, is formed into a chamfered surface that is at an inclined angle relative to a remaining portion of said first side section, and said attachment piece is provided at least at the prescribed corner section of said case member.

2. The display device according to claim 1,
wherein the first portion of the first side section of said first case member is formed into the chamfered surface so that a space is formed in the prescribed corner section of said case member, and
wherein said attachment piece is housed within said space in the prescribed corner section of said case member.

3. The display device according to claim 1, wherein said attachment piece is provided as a unified part of the prescribed corner section of said case member.

4. The display device according to claim 3,
wherein said case member is constituted of a plate-shaped member, and
wherein a piece bent from said plate-shaped member serves as said attachment piece.

5. The display device according to claim 1, wherein said attachment piece is provided on the first portion of the first side section of said first case member.

6. The display device according to claim 1,
wherein a second portion of a second side section of said second case member, which second portion is disposed at a location of the prescribed corner section of said case member, is formed into a chamfered surface that extends along the first portion of the first side section of said first case member, and
wherein said attachment piece is provided on the second portion of the second side section of said second case member.

7. The display device according to claim 1,
wherein said backlight unit includes a light-emitting element and a light guide plate having a plurality of corners, and
wherein said light-emitting element is attached to the first portion of the first side section of said first case member so that said light-emitting element is disposed at least at one corner of the plurality of corners of said light guide plate.

8. The display device according to claim 7,
wherein a portion of a side surface of said light guide plate at a corner at which said light-emitting element is disposed is formed into a surface at an inclined angle relative to other portion of the side surface, and
wherein said light-emitting element is attached to the first portion of the first side section of said first case member so that said light-emitting element is disposed to face the inclined surface of the side surface of said light guide plate.

9. The display device according to claim 8, wherein the first portion of the first side section of said first case member is formed into the chamfered surface that extends along the corresponding inclined side surfaces of said light guide plate.
